(19) United States
(12) Patent Application Publication
(10) Pub. No.: US 2004/0203734 A1
(43) Pub. Date: Oct. 14, 2004

(54) Wireless communication system

(76) Inventor: Yoshiyuki Ishii, Tokyo (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/182,572

(22) PCT Filed: Nov. 6, 2001
(86) PCT No.: PCT/JP01/09684

(30) Foreign Application Priority Data
Aug. 23, 2001 (JP) 2001-252419

(51) Int. Cl. H04Q 7/20; H04M 1/00; H04B 1/38

(52) U.S. Cl. 455/426.1; 455/561

(57) ABSTRACT

One or more first base stations (2) capable of radio-communicating with one or more terminal stations (1C) are connected with a first communication line or a trunk network. One or more second base stations (3) are connected with a second communication line or a local area network and performs radio-communication of control information with the first base stations (2) and radio-communication of data with a terminal station (1). A service control station (4) connected with the first communication line manages the terminal station (1) having accessed to the second base stations (3), through the first base stations (2).

### TECHNICAL FIELD

The present invention relates to a wireless communication system and a wireless communication method for performing wireless communication between a terminal station and a base station to provide a wireless communication service, and relates to a base station used therein.

### BACKGROUND ART

Conventionally, as a wireless communication system for providing a wireless communication service by performing wireless communication between a terminal station and a base station, there is a cellular mobile communication system using a mobile telephone device as a terminal station, or the like. As the mobile communication system, there are systems such as PHS (Personal Handyphone System), PDC (Personal Digital Cellular), and a W-CDMA (Wideband-Code Division Multiple Access) method.

In these mobile communication systems, service is provided based on a wireless access technology, a wired network technology, and a service control technology such as charging for the use of a line or management on a terminal station.

PHS, one of the mobile communication systems, will be explained as an example. Incidentally, PHS is an existing mobile communication system of a TDMA-TDD (Time Division Multiple Access-Time Division Duplex) method utilized in Japan. FIG. 7 is a block diagram showing the configuration of PHS. FIG. 8 is a diagram showing a frame format used in PHS. FIG. 9 is a timing chart showing control channels of PHS.

In FIG. 7, a terminal station 1C is a terminal device such as a PHS telephone. Further, a base station 102 is a device for performing wireless communication with one or plural terminal stations 1C in its own cell, which is connected to an ISDN (Integrated Services Digital Network) network L1 being a backbone network. Although only one base station 102 is shown in FIG. 7, plural base stations 102 are actually provided and connected with each other via the ISDN network L1.

Furthermore, a service control station 104 is a device connected to the ISDN network L1 to which the base station 102 is connected, for performing processing such as location registration of the terminal station 1C and charging based on a line use amount in the base station 102.

In PHS, one frame is transmitted in five milliseconds in a wireless link part and, as shown in FIG. 8, one frame is divided into eight slots SL1 to SL8 in which four slots SL1 to SL4 are used for uplink and the remaining four slots SL5 to SL8 are used for downlink. Each one of the respective four slots, SL2 or SL6, is used for a control channel CCH by all the terminal stations 1C in the cell. Then, pairs of slots SL1 and SL5, SL3 and SL7, and SL4 and SL8 out of the remaining slots SL1, SL3, SL4, SL5, SL7, and SL8 are respectively used for communication channels TCH1, TCH2, and TCH3 by one terminal station 1C.

In addition, as shown in FIG. 9, the control channel CCH includes a broadcasting control channel BCCH, an signaling control channel SCCH, a paging channel PCH, and the like, and these are repeatedly assigned to the predetermined slots SL2 and SL6 in a prescribed order.

The communication channels are assigned to the slots available at the point when a call terminates at the terminal station 1C or a call originates from the terminal station 1C. Incidentally, when the call terminates, call termination information is transmitted from the base station 102 to the terminal station 1C via the paging channel PCH. Then, via the signaling control channel SCCH, a channel establishment request is transmitted from the terminal station 1C to the base station 102 and channel assignment is transmitted from the base station 102 to the terminal station 1C so that wireless communication is established between the base station 102 and the terminal station 1C.

Although PHS has been explained as the example of the existing wireless communication system, wireless communication is performed between the base station 102 and the terminal station 1C also in another wireless communication system.

In general, in the existing wireless communication system, line capacity in wireless communication between the terminal station 1C and the base station 102 is determined by its standard. For example, line capacity of data communication in PDC is 9.6 kbps and line capacity of data communication conforming to PIAFS (PHS Internet Access Forum Standard) is 32 kbps or 64 kbps.

Meanwhile, since the throughput of an electronic equipment is increasing day by day with the advance of electronic equipment, processable data quantity also increases and a demand for larger communication capacity is rising.

In order to increase communication capacity, it is necessary to construct a new wireless communication system independently of the existing wireless communication system or to make substantial changes to specifications of the base station 102 and the terminal station 1C used in the existing wireless communication system, which costs a great deal for setting up or replacing devices.

The present invention is made in view of the aforementioned problem, and its object is to obtain a wireless communication system and a wireless communication method capable of increasing communication capacity at a low cost while making use of facilities of an existing wireless communication system, and a base station used in the wireless communication system.

### DISCLOSURE OF THE INVENTION

A wireless communication system of the present invention comprises: a first base station connected to a first communication line which is a backbone network and capable of performing wireless communication with one or plural terminal stations; a second base station connected to a second communication line which is a local area network, for performing wireless communication on control information with the first base station and performing wireless communication on data with the terminal station thereof; and a service control station connected to the first communication line, for managing the terminal station which has accessed the first base station as well as managing, through the first base station, the terminal station which has accessed the second base station.

Accordingly, this can increase communication capacity at a low cost while making use of facilities of an existing wireless communication system.

Further, in addition to the wireless communication system of the aforementioned invention, in a wireless communication system of the present invention, the second base station transmits a line use amount arisen from wireless communication with each of the terminal stations to the first base station, the first base station transmits the line use amount of each of the terminal stations received from the second base station to the service control station, and the service control station performs charging management on each of the terminal stations based on the line use amount of each of the terminal stations.

As a result, the service control station performs the charging management for the use of the first base station by the terminal station and can additionally perform the charging management for the use of the second base station by the terminal station so that a wireless communication system providing a high-speed wireless communication service can be realized at a low cost without necessity for newly providing another service control station.

Furthermore, in addition to the wireless communication systems of the aforementioned respective inventions, in a wireless communication system of the present invention, the first base station executes wireless communication of a TDMA method, and the second base station generates a frame pulse signal synchronizing with a frame of wireless communication by the first base station based on a control channel of the first base station and executes wireless communication with the terminal station in synchronization with the frame pulse signal.

Consequently, it is possible to reduce the scale of a circuit for synchronization of wireless communication between the second base station and the terminal station. In other words, the circuit scale becomes smaller compared with that in a case that circuits for synchronization of wireless communication between the second base station and the terminal station are separately provided in the second base station and terminal station independently of synchronization of wireless communication between the first base station and the terminal station.

Moreover, in addition to the wireless communication systems of the aforementioned respective inventions, in a wireless communication system of the present invention, the second base station assigns one frequency band per terminal station and assigns all slots for a communication channel in the frame to the terminal station so that wireless communication of the TDMA method synchronizing with the first base station is executed with the terminal station.

Accordingly, in a case that the first base station executes wireless communication of the TDMA method as a PHS base station or the like does, it is possible to increase line capacity easily under the TDMA method by the second base station.

Further, in addition to the wireless communication systems of the aforementioned respective inventions, in a wireless communication system of the present invention, a base station of an existing cellular mobile communication system is used as the first base station.

Accordingly, the wireless communication system can be realized at a low cost by adding the second base stations and the local area network which connects them with each other to the existing cellular mobile communication system.

Furthermore, in addition to the wireless communication systems of the aforementioned respective inventions, in a wireless communication system of the present invention, the second base station has a base station identifier as its own identifier to the terminal station and a terminal station identifier for the terminal station which the first base station can accommodate as its own identifier to the first base station.

As a result, the wireless communication system can be realized at a lower cost without giving almost any modification to functions of the first base station of the existing cellular mobile communication system.

Moreover, in addition to the wireless communication systems of the aforementioned respective inventions, in a wireless communication system of the present invention, the second base station transmits to and receives from the first base station control information on the terminal station, which has accessed the second base station, via a control channel for the first base station to transmit/receive the control information to/from the terminal station.

Consequently, the wireless communication system can be realized at a lower cost without necessity for additionally setting up another channel between the first base station and the second base station as well as without giving almost any modification to the functions of the first base station.

Further, in addition to the wireless communication systems of the aforementioned respective inventions, in a wireless communication system of the present invention, the location of the terminal station is registered in the service control station via the second base station and the first base station.

Accordingly, even if the first base station cannot be accessed directly, the terminal station can become able to use this wireless communication system if it can access the second base station, which makes it possible to provide the high-speed wireless communication service to a user more securely.

Furthermore, in addition to the wireless communication systems of the aforementioned respective inventions, in a wireless communication system of the present invention, the local area network to which the second base station is connected is an Ethernet™ network.

As a result, since a network interface for the Ethernet is available at a low cost, this wireless communication system can be realized at a low cost.

A base station of the present invention comprises: a wireless communication part for performing wireless communication with a base station of a different wireless communication system and one or plural terminal stations; a network interface part connected to a local area network; and a controlling part for controlling the wireless communication part to transmit control information on the terminal station which performs wireless communication with the wireless communication part to a service control station of the different wireless communication system through the base station of the different wireless communication system.

Consequently, a wireless communication system for increasing communication capacity can be realized at a low cost while making use of facilities of an existing wireless communication system.

Further, in addition to the base station of the aforementioned invention, in a base station of the present invention, the controlling part transmits a line use amount arisen from wireless communication with each of the terminal stations to the base station of the different wireless communication system and makes the service control station perform charging management on each of the terminal stations based on the line use amount of each of the terminal stations.

Accordingly, the service control station performs the charging management for the use of the base station of the different wireless communication system and can additionally perform the charging management for the use of this base station by the terminal station so that the wireless communication system to which the base station belongs can be realized at a low cost without necessity for newly providing another service control station.

Furthermore, in addition to the base stations of the aforementioned respective inventions, a base station of the present invention comprises a frame pulse generating part for generating a frame pulse signal synchronizing with a frame in wireless communication of the different wireless communication system based on a control channel of wireless communication of a TDMA method provided by the different wireless communication system, in which the wireless communication part executes wireless communication with the terminal station in synchronization with the frame pulse signal generated by the frame pulse generating part.

As a result, it is possible to reduce the scale of a circuit for synchronization of wireless communication between the base station and the terminal station. In other words, the circuit scale becomes smaller compared with that in a case that circuits for synchronization of wireless communication between the base station and the terminal station are separately provided in the base station and terminal station independently of the different wireless communication system.

Moreover, in addition to the base stations of the aforementioned respective inventions, in a base station of the present invention, the wireless communication part assigns one frequency band per terminal station and assigns all slots for a communication channel in the frame to the terminal station so that wireless communication of the TDMA method synchronizing with the different wireless communication system is executed with the terminal station.

Consequently, in a case that the base station of the different wireless communication system executes wireless communication of the TDMA method as a PHS base station or the like does, it is possible to increase line capacity easily under the TDMA method by the base station.

Further, in addition to the base stations of the aforementioned respective inventions, in a base station of the present invention, the wireless communication part has a base station identifier as its own identifier to the terminal station and a terminal station identifier of the different wireless communication system which is an existing cellular mobile communication system as its own identifier to the base station of the different wireless communication system.

Accordingly, the wireless communication system to which the base station belongs can be realized at a lower cost without giving almost any modification to functions of the base station of the existing cellular mobile communication system.

Furthermore, in addition to the base stations of the aforementioned respective inventions, in a base station of the present invention, the wireless communication part transmits/receives control information on the terminal station, which has accessed the wireless communication part, to/from the base station of the different wireless communication system, which is an existing cellular mobile communication system, via a control channel of the different wireless communication system.

As a result, the wireless communication system to which the base station belongs can be realized at a lower cost without necessity for additionally setting up another channel between this base station and the base station of the existing cellular mobile communication system as well as without giving almost any modification to the functions of the base station of the existing cellular mobile communication system.

Moreover, in addition to the base stations of the aforementioned respective inventions, in a base station of the present invention, the controlling part controls the wireless communication part to transmit the control information on the terminal station, which has accessed the wireless communication part, to the base station of the different wireless communication system so that the location of the terminal station is registered in the service control station.

Consequently, even if the base station of the different wireless communication system cannot be accessed directly, a high-speed wireless communication service can be provided to a user if the base station can be accessed.

Further, in addition to the base stations of the aforementioned respective inventions, in a base station of the present invention, an Ethernet network can be used as the local area network.

Since an network interface for the Ethernet is available at a low cost, the base station can be realized at a low cost.

A wireless communication method of the present invention comprises the steps of: registering the location of a terminal station in a service control station connected to a backbone network through a first base station connected to the backbone network; performing wireless communication between a second base station connected to a local area network and the terminal station: and transmitting a line use amount arisen from wireless communication between the second base station and the terminal station from the second base station to the service control station through the first base station.

Accordingly, this can increase communication capacity at a low cost while making use of facilities of an existing wireless communication system.

Further, in addition to the wireless communication method of the aforementioned invention, in a wireless communication method of the present invention, the location of the terminal station is registered in the service control station through the first base station and the second base station.

As a result, even if the first base station cannot be accessed directly, the terminal station becomes able to use this wireless communication system if it can access the second base station, which makes it possible to provide a high-speed wireless communication service to a user more securely.

### BRIEF DESCRIPTION OF DRAWINGS

FIG. 1 is a block diagram showing the configuration of a wireless communication system according to an embodiment of the present invention;

FIG. 2 is a block diagram showing the configuration of a second base station in the wireless communication system of the embodiment;

FIG. 3 is a timing chart showing an example of a frame pulse signal generated by a frame pulse generating part of the second base station shown in FIG. 2;

FIG. 4 is a block diagram showing the configuration of a terminal station of the wireless communication system according to the embodiment;

FIG. 5 is a diagram showing an example of a sequence of wireless communication in the wireless communication system of the embodiment;

FIG. 6 is a diagram showing an example of channel assignment to slots in the wireless communication system of the embodiment;

FIG. 7 is a block diagram showing the configuration of PHS;

FIG. 8 is a diagram showing a frame format used in PHS; and

FIG. 9 is a timing chart showing control channels of PHS.

### BEST MODE FOR CARRYING OUT THE INVENTION

An embodiment of the present invention will be explained below based on the drawings.

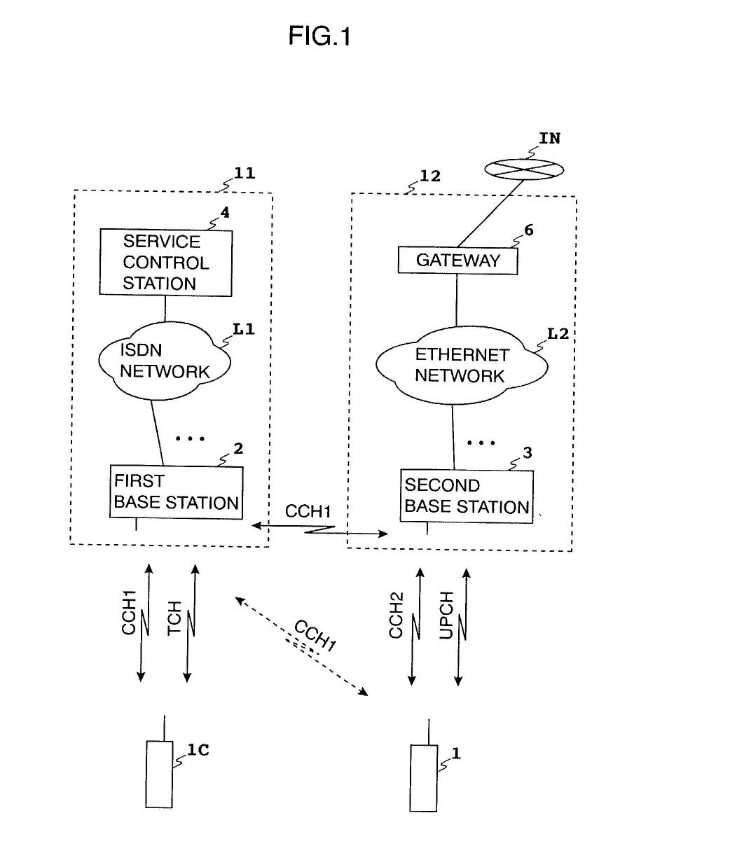

FIG. 1 is a block diagram showing the configuration of a wireless communication system according to the embodiment of the present invention. In FIG. 1, a terminal station 1 is a device such as a mobile telephone, PDA (Personal Digital Assistant), a computer, or the like for performing wireless communication with a second base station 3. Incidentally, it is also suitable that the terminal station 1 can transmit and receive control information via a control channel of a first base station 2. In this case, the terminal station 1 can directly access the first base station 2 to register its location.

Further, the first base station 2 is a base station of an existing wireless communication system 11 such as PHS. Incidentally, if the existing wireless communication system 11 is PHS, the first base station 2 performs wireless communication by a TDMA-TDD method.

Furthermore, the second base station 3 is a base station of a newly-established wireless communication system 12, which is connected to Internet IN, for providing a high-speed wireless data communication service to the terminal station 1.

Although only one first base station 2 and one second base station 3 are shown in FIG. 1, plural first base stations 2 and plural second base stations 3 are actually provided and the plural first base stations 2 are connected with each other via an ISDN network L1 and the plural second base stations 3 are connected with each other via an Ethernet network L2. Moreover, the second base stations 3 are set in cells of corresponding first base stations 2. On this occasion, it is naturally suitable that the second base stations 3 are set in the same location as the first base stations 2. However, a one-to-one correspondence is not necessary between the first base stations 2 and the second base stations 3.

Further, the second base station 3 has a base station identifier CS-ID as its own identifier to the terminal station 1 and terminal station identifiers PS-ID as for terminal stations 1C and 1 which the first base station 2 can accommodate as its own identifiers to the first base station 2.

Furthermore, a service control station 4 is a service control station of the existing wireless communication system 11 for managing location registration of the terminal station 1C and terminal station 1 and charging to them.

Moreover, a gateway 6 is a device for connecting the newly-established wireless communication system 12 to the Internet IN.

In other words, a wireless communication system according to the embodiment is realized by using the existing wireless communication system 11 which is a different wireless communication system from the newly-established wireless communication system 12.

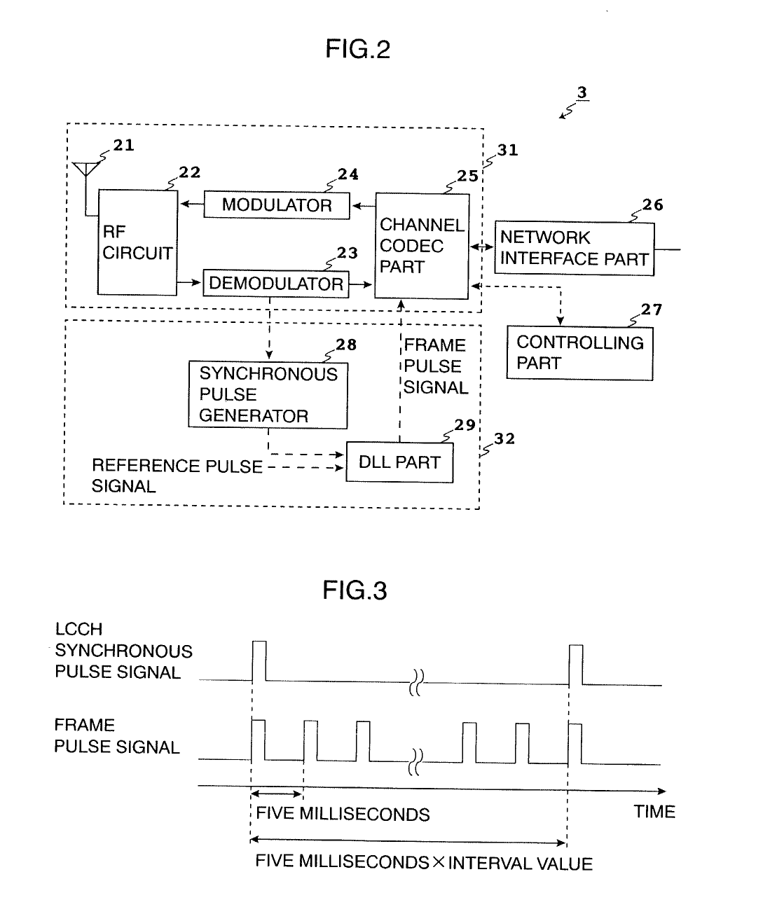

FIG. 2 is a block diagram showing the configuration of the second base station 3 in the wireless communication system according to the embodiment. In FIG. 2, an antenna 21 is a device for sensing or emitting radio waves and an RF circuit 22 is a circuit for receiving an RF (radio Frequency) signal sensed by the antenna 21 as well as amplifying the RF signal and applying it to the antenna 21 to be emitted.

In addition, a demodulator 23 is a circuit for demodulating the RF signal received by the RF circuit 22. Further, a modulator 24 is a circuit for modulating a signal to be transmitted into the RF signal.

Furthermore, a channel codec part 25 is a circuit for decoding data received from one or plural terminal stations 1 and demodulated, as well as encoding data to be later modulated and transmitted to the terminal station 1 in accordance with a predetermined access method such as TDMA.

Incidentally, these antenna 21, RF circuit 22, demodulator 23, modulator 24, channel codec part 25, and so on compose a wireless communication part 31 for performing wireless communication with the first base station 2 of the existing wireless communication system 11 and one or plural terminal stations 1.

A network interface part 26 is a circuit connected to the Ethernet network L2, for transmitting data received by the wireless communication part 31 to the Ethernet network L2 and supplying data received from the Ethernet network L2 to the wireless communication part 31 to make the wireless communication part 31 transmit the data to the terminal station 1.

A controlling part 27 is a circuit for controlling the wireless communication part 31.

A frame pulse generating part 32 is a circuit group composed of a synchronous pulse generator 28, a DLL part 29, and so on, for generating a frame pulse signal synchronizing with a frame in wireless communication of the existing wireless communication system 11 based on a control channel of wireless communication of the TDMA method provided by the existing wireless communication system 11. FIG. 3 is a timing chart showing an example of the frame pulse signal generated by the frame pulse generating part 32 of the second base station 3 shown in FIG. 2.

The synchronous pulse generator 28 is a circuit for outputting an LCCH synchronous pulse signal when starting (or ending) of a logical control channel LCCH is detected from a signal demodulated by the demodulator 23, as shown in FIG. 3. Incidentally, when the first base station 2 is a PHS base station, the starting (or ending) of the logical control channel LCCH is detected at intervals of a predetermined integral multiple of five milliseconds since a frame cycle of PHS is five milliseconds.

The DLL part 29 is a circuit for synchronizing a reference pulse signal, which is a pulse signal having the same cycle with the frame cycle, with the LCCH synchronous pulse signal generated by the synchronous pulse generator 28 based on a delay locked loop and outputting it as the frame pulse signal, as shown in FIG. 3. Incidentally, the reference pulse signal is generated, for example, by a not-shown counter to reduce pulses at a predetermined rate in a pulse signal of a certain clock frequency which has been generated by a not-shown oscillator. In addition, when the first base station 2 is the PHS base station, a cycle of the reference pulse signal is five milliseconds.

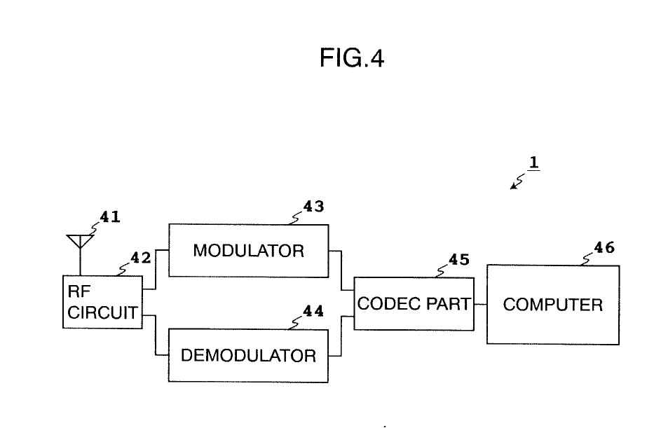

FIG. 4 is a block diagram showing the configuration of the terminal station 1 in the wireless communication system according to the embodiment. In FIG. 4, an antenna 41 is a device for sensing or emitting radio waves and an RF circuit 42 is a circuit for receiving an RF signal sensed by the antenna 41 as well as amplifying the RF signal and applying it to the antenna 41 so that the RF signal is emitted.

In addition, a demodulator 43 is a circuit for demodulating the RF signal received by the RF circuit 42. Further, a modulator 44 is a circuit for modulating a signal to be transmitted into the RF signal.

Furthermore, a codec part 45 is a circuit for decoding data received from the second base station 3 and demodulated, as well as encoding data to be later modulated and transmitted to the second base station 3 in accordance with a predetermined access method such as TDMA.

Moreover, a computer 46 is a device for performing various kinds of information processing to control the codec part 45 and send/receive data to/from the codec part 45. Incidentally, when the terminal station 1 is a mobile telephone, an embedded microcomputer is the computer 46. When the terminal station 1 is PDA or a handheld computer, the device itself is the computer 46 and the other components shown in FIG. 4 are embedded in the device, or a PC card or the like in which the other components are embedded is connected to the device via a predetermined interface.

Incidentally, the terminal station 1 can perform voice communication or the like by using the first base station 2 similarly to the conventional terminal station 1C, if the same circuit as that of the conventional terminal station 1C is added to the circuits shown in FIG. 4.

Subsequently, a wireless communication method in the above-described wireless communication system will be explained.

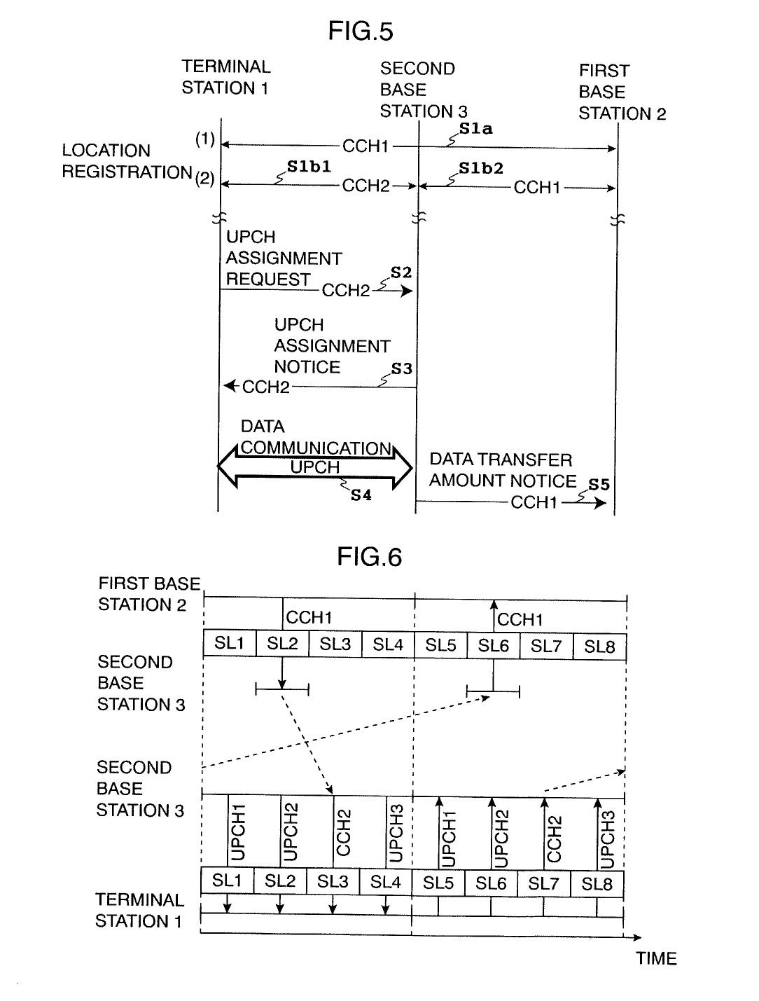

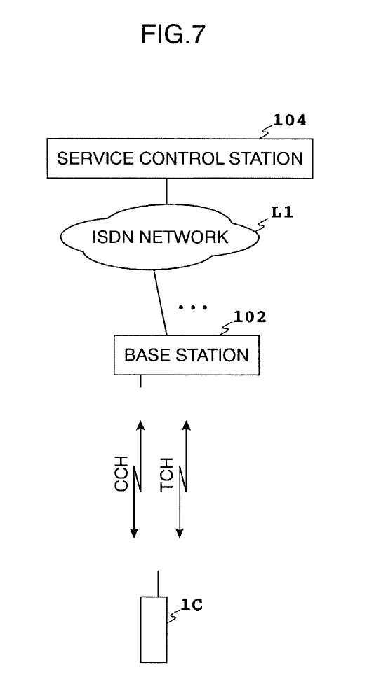

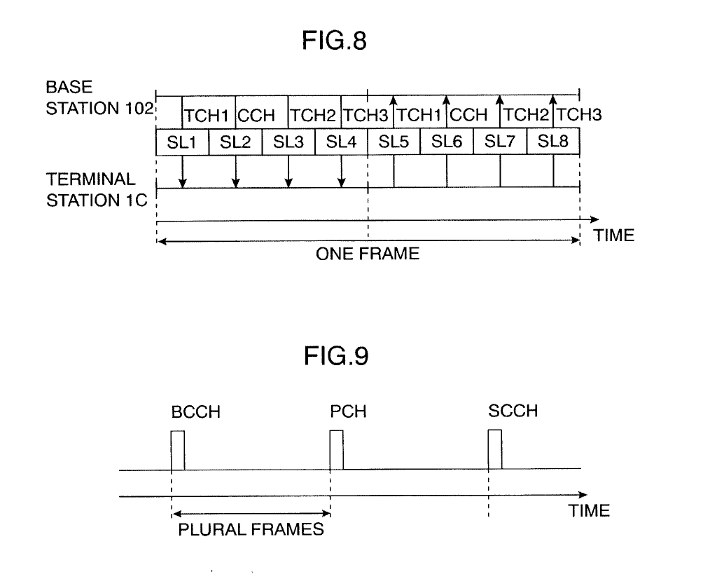

FIG. 5 is a diagram showing an example of a sequence of wireless communication in the wireless communication system according to the embodiment. FIG. 6 is a diagram showing an example of channel assignment to slots in the wireless communication system of the embodiment.

First, when the terminal station 1 moves from a cell to a cell or starts operation, it executes location registration. At this time, if a control channel CCH1 of the first base station 2 of the existing wireless communication system 11 is available, the terminal station 1 transmits/receives control information to/from the first base station 2 via the control channel CCH1 to allow the service control station 4 of the existing wireless communication system 11 to perform the location registration (step S1a).

Meanwhile, if the control channel CCH1 of the first base station 2 of the existing wireless communication system 11 is not available, the terminal station 1 transmits/receives the control information to/from the second base station 3 via a control channel CCH2 (step S1b1), and the second base station 3 transmits/receives the control information to/from the first base station 2 via the control channel CCH1 of the first base station 2 so that the location registration is performed in the service control station 4 of the existing wireless communication system 11 (step S1b2). In this case, area information and the like in the control information received from the first base station 2 is rewritten into information corresponding to the second base station 3 by the second base station 3.

For example, in a case that each channel is assigned to each slot as shown in FIG. 6, in a down direction, the control information is first transferred from the first base station 2 to the second base station 3 via the control channel CCH1 assigned to a slot SL2 of the first base station 2, and the control information is then transferred from the second base station 3 to the terminal station 1 via the control channel CCH2 assigned to a slot SL3 of the second base station 3 in the same frame. Further, in this case, in an up direction, the control information is first transferred from the terminal station 1 to the second base station 3 via the control channel CCH2 assigned to a slot SL7 of the second base station 3, and the control information is then transferred from the second base terminal 3 to the first base station 2 via the control channel CCH1 assigned to a slot SL6 of the first base station 2 in the next frame.

Incidentally, the control channel CCH1 and control channel CCH2 can be assigned to the same frequency or can be assigned to different frequencies respectively. If the control channel CCH1 and control channel CCH2 are assigned to the same frequency, the first base station 2 and second base station 3 have different base station identifiers CS-ID respectively. In this case, the second base station 3 rewrites a value of the base station identifier CS-ID included in the control information received from the first base station 2 into its own value, and thereafter transmits the control information to the terminal station 1. Further, in this case, the second base station 3 rewrites a value of the base station identifier CS-ID included in the control information received from the terminal station 1 from its own value to a value of the first base station 2, and thereafter transmits the control information to the first base station 2. Furthermore, in this case, the control channel CCH1 and control channel CCH2 are composed of LCCH frames different from each other.

If the control channel CCH1 and control channel CCH2 are assigned to the different frequencies, the conversion processing of the base station identifier CS-ID as described above is not necessary.

Next, in a link channel establishment phase, the terminal station 1 first transmits an assignment request for a high-speed packet channel UPCH, which is a high-speed communication channel for user data, to the second base station 3 via the control channel CCH2 (step S2). When the second base station 3 receives the assignment request for the high-speed packet channel UPCH, it performs carrier sensing to find available frequency bands at that time, assigns one frequency band to the terminal station 1, assigns all the slots for the communication channel in the frame except the a slot for the control channel, and notifies the terminal station 1 of the assigned slots via the control channel CCH2 (step 3). At this time, if the service control station 4 is informed that the channel UPCH is established between the second base station 3 and the terminal station 1, the control information including information on the establishment is transmitted from the second base station 3 to the first base station 2 via the control channel CCH1, and thereafter transmitted from the first base station 2 to the service control station 4 via the ISDN network L1.

Moreover, if each channel is assigned to each slot as shown in FIG. 6, the UPCH assignment request is transmitted from the terminal station 1 to the second base station 3 via the control channel CCH2 in the up direction assigned to the slot SL 7. Then, three high-speed packet channels UPCH1, UPCH2, and UPCH 3 in the down direction are assigned to the slots SL1, SL2, and SL4 respectively and three high-speed packet channels UPCH1, UPCH2, and UPCH 3 in the up direction are assigned to the slots SL5, SL6, and SL8 respectively. After the high-speed packet channels UPCH1, UPCH2, and UPCH3 of each group are assigned, UPCH assignment notice is transmitted from the second base station 3 to the terminal station 1 via the control channel CCH2 in the down direction assigned to the slot SL3.

Thereafter, processing in a service channel establishment phase is performed in the same LAPDC (Link Access Procedure for Digital Cordless) as in PHS.

Then, in a high-speed communication phase, data communication is executed between the second base station 3 and the terminal station 1 via the high-speed packet channel UPCH (step 4). Data in the data communication is transmitted to and received from the Ethernet network L2 by the second base station 3. At this time, the channel codec part 25 of the second base station 3 counts the number of transmitted/received data packets by each terminal station identifier PS-ID of the terminal station 1 to obtain a line use amount of each terminal station 1.

Incidentally, in the high-speed communication phase, it is also suitable to terminate TCP/IP (Transmission Control Protocol/Internet Protocol) in the network interface part 26 of the second base station 3 and to use another predetermined protocol between the second base station 3 and the terminal station 1.

Thereafter, when the data communication is completed, the second base station 3 performs random access to the first base station 2 via the control channel CCH1 in order to transmit the data transfer amount arisen from the data communication of this time, that is, the line use amount, together with the identifier PS-ID of the terminal station 1 to the first base station 2 after encrypting them (step S5). The first base station 2 transmits the data transfer amount in the second base station 3 to the service control station 4 together with the identifier of the terminal station 1. The service control station 4 performs processing for charging an amount, which is based on the data transfer amount, to the terminal station 1 having the identifier.

Thus, in the above-described wireless communication system, the high-speed wireless communication service of the newly-established wireless communication system 12 is provided to the terminal station 1.

Subsequently, the operation of the second base station 3 of the aforementioned wireless communication system will be explained.

In the second base station 3 shown in FIG. 2, user data received by the wireless communication part 31 is transmitted to the Ethernet network L2 by the network interface part 26 and user data from the Ethernet network L2 is supplied to the wireless communication part 31.

Meanwhile, the synchronous pulse generator 28 of the frame pulse generating part 32 detects the starting or ending of the logical control channel LCCH from a bit sequence after demodulation with regard to the control channel of the first base station 2 which operates according to the TDMA method, generates the LCCH synchronous pulse signal at timing of the detection as shown in FIG. 3, and supplies it to the DLL part 29. Incidentally, the starting or ending of the logical control channel LCCH is recognized by detecting a specific bit pattern in a starting slot or ending slot of the logical control channel. The DLL part 29 creates the frame pulse signal by synchronizing the reference pulse signal having the same cycle as the frame cycle with the LCCH synchronous pulse signal, and supplies it to the channel codec part 25 of the wireless communication part 31. Then, the channel codec part 25 divides the frame synchronizing with the frame pulse signal into the same number of slots as the number of slots of the first base station 2 and performs channel codec according to the TDMA method through the use of the slots synchronizing with the slots of the first base station 2. Consequently, as shown in FIG. 6, the slots of the first base station 2 and the slots of the second base station 3 synchronize with each other. Further, the codec part 45 of the terminal station 1 operates in synchronization with a radio signal from the second base station 3 so that synchronization of wireless communication between the second base station 3 and the terminal station 1 can be achieved.

The channel codec part 25 encodes user data to be transmitted to the terminal station 1 into transmitting data for each channel and supplies the encoded transmitting data to the modulator 24. The modulator 24 modulates the transmitting data for each channel received from the channel codec part 25 according to a predetermined modulation method and supplies the modulated RF signal to the RF circuit 22, and the RF circuit 22 amplifies the RF signal and applies it to the antenna 21 so that the RF signal is emitted as radio waves.

Furthermore, the RF signal sensed by the antenna 21 is received by the RF circuit 22 and demodulated according to a predetermined demodulation method, and receiving data after the demodulation is supplied to the channel codec part 25. The channel codec part 25 decodes the receiving data from each channel into user data from the terminal station 1 and supplies it to the network interface part 26.

Thus, in the second base station 3, the data received from the Ethernet network L2 is transmitted through the network interface part 26 and the wireless communication part 31 then to the terminal station 1 on radio wave, and the data from the terminal station 1 is received by the wireless communication part 31 and transmitted to the Ethernet network L2 through the network interface part 26.

As stated above, according to the aforementioned embodiment, the first base station 2 capable of performing wireless communication with one or plural terminal stations 1C and 1 is connected to the ISDN network L1 which is a backbone network, and the second base station 3 is connected to the Ethernet network L2 which is the local area network. Then, the second base station 3 performs wireless communication on the control information with the first base station 2, and performs wireless communication on data with the terminal station 1 based on the control signal thereof. Further, the service control station 4 connected to the ISDN network L1 manages the terminal station 1C which has accessed the first base station 2 and manages the terminal station 1 which has accessed the second base station 3 through the first base station 2. Consequently, communication capacity can be increased at a low cost while facilities of the existing wireless communication system 11 are utilized.

Furthermore, according to the above-described embodiment, after the second base station 3 transmits a line use amount arisen from wireless communication with each terminal station 1 to the first base station 2, the first base station 2 transmits the line use amount of each terminal station 1 received from the second base station 3 to the service control station 4, and the service control station 4 performs charging management on each terminal station 1 based on the line use amount of each terminal station 1. Consequently, the service control station 4, which performs the charging management for the use of the first base station 2 by the terminal station 1, can also perform the charging management for the use of the second base station 3 by the terminal station 1 so that the wireless communication system providing a high-speed wireless communication service can be realized at a low cost without necessity for newly providing another service control station.

Moreover, according to the above-described embodiment, the first base station 2 executes wireless communication of the TDMA method; the second base station 3 generates the frame pulse signal synchronizing with the frame of wireless communication by the first base station 2 based on the control channel of the first base station 2, and performs wireless communication with the terminal station 1 in synchronization with the frame pulse signal. Consequently, it is possible to reduce the scale of a circuit for synchronization of wireless communication between the second base station 3 and the terminal station 1. In other words, the circuit scale becomes smaller compared with that in a case that circuits for the synchronization are provided in the second base station 3 and the terminal station 1 independently of synchronization of wireless communication between the first base station 2 and the terminal stations 1C and 1.

In addition, according to the above-described embodiment, the second base station 3 performs wireless communication of the TDMA method with the terminal station 1 in synchronization with the first base station 2 by assigning one frequency band to one terminal station 1 and assigning all the slots for the communication channel in the frame to the terminal station 1. Consequently, if the first base station 2 executes wireless communication of the TDMA method as the PHS base station or the like does, it is possible to increase line capacity easily under the TDMA method by the second base station 3.

Further, according to the above-described embodiment, since a base station of an existing cellular mobile communication system is used as the first base station 2, the wireless communication system can be realized at a low cost by adding the second base stations 3 and the Ethernet network L1 which connects them with each other to the existing cellular mobile communication system.

Furthermore, according to the above-described embodiment, the second base station 3 has the base station identifier CS-ID as its own identifier to the terminal station 1 and the terminal station identifier PS-ID for the terminal station 1C or 1 which the first base station 2 can accommodate as its own identifier to the first base station 2. Consequently, the wireless communication system can be realized at a lower cost without giving almost any modification to functions of the first base station 2 of the existing cellular mobile communication system.

Moreover, according to the above-described embodiment, the second base station 3 transmits to and receives from the first base station 2 the control information on the terminal station 1 which has accessed the second base station 3, via the control channel CCH1 which is for the first base station 2 to transmit/receive the control information to/from the terminal stations 1C and 1. Consequently, the wireless communication system can be realized at a lower cost without necessity for additionally setting up a channel between the first base station 2 and the second base station 3 as well as without giving almost any modification to the functions of the first base station 2.

In addition, according to the above-described embodiment, since the location of the terminal station 1 is registered in the service control station 4 through the second base station 3 and the first base station 2, even if the first base station 2 cannot be accessed directly, the terminal station 1 becomes able to use this wireless communication system if it can access the second base station 3, which makes it possible to provide the high-speed wireless communication service to a user more securely.

Further, according to the above-described embodiment, the Ethernet network L2 is used as the local area network to which the second base station 3 is connected. A network interface for the Ethernet is available at a low cost, and therefore this wireless communication system can be realized at a low cost.

Incidentally, the Ethernet network L2 is used as the local area network to which the second base station 3 is connected in the above-described embodiment, and the Ethernet can conform to any standard. Furthermore, the Ethernet network L2 is structured with its physical length being extended by a bridge, a router, and the like. Thus, the local area network described herein is not limited to a network built in a narrow area but indicates a computer network using a local area network technology. In addition, in place of the Ethernet network L2, a local area network conforming to another standard can be also used.

Further, although one gateway 6 is used in the above-described embodiment, plural gateways 6 can be provided.

Furthermore, although PHS is taken as an example of the existing wireless communication system 11 in the above-described embodiment, another existing wireless communication system can be used. On this occasion, the existing wireless communication system 11 may not need to adopt the TDMA method as a multiple access method.

Moreover, although the second base station 3 and terminal station 1 operates according to the TDMA-TDD method in the above-described embodiment, it is also suitable that they operates according to a TDMA-FDD (TDMA-Frequency Division Duplex) method even if the existing wireless communication system 11 is PHS. In addition, it is also possible that the second base station 3 and terminal station 1 operates according to an FDMA (Frequency Division Multiple Access) method, a CDMA (Code Division Multiple Access) method, or the like even if the existing wireless communication system 11 is PHS.

Further, although the second base station 3 assigns the same number of the slots to the communication channel UPCH of an uplink and the communication channel UPCH of a downlink respectively in the above-described embodiment, it is also possible to assign the different numbers of the slots to the communication channel UPCH of the uplink and the communication channel UPCH of the downlink in accordance with a data transmission amount of each line or other necessity so that line capacity in the up direction and down direction become asymmetrical.

### INDUSTRIAL AVAILABILITY

As described above, communication capacity can be increased at a low cost while facilities of the existing wireless communication system are utilized.

1. A wireless communication system, comprising:
a first base station connected to a first communication line which is a backbone network, and capable of performing wireless communication with one or plural terminal stations;
a second base station connected to a second communication line which is a local area network, for performing wireless communication on control information with said first base station and performing wireless communication on data with the terminal station thereof; and
a service control station connected to the first communication line, for managing the terminal station which has accessed said first base station as well as managing, through said first base station, the terminal station which has accessed said second base station.

2. The wireless communication system according to claim 1,
wherein said second base station transmits a line use amount arisen from wireless communication with each of the terminal stations to said first base station,
said first base station transmits the line use amount of each of the terminal stations received from said second base station to said service control station, and
said service control station performs charging management on each of the terminal stations based on the line use amount of each of the terminal stations.

3. The wireless communication system according to claim 1,
wherein said first base station executes wireless communication of a TDMA method, and
said second base station generates a frame pulse signal synchronizing with a frame of wireless communication by said first base station based on a control channel of said first base station, and executes wireless communication with the terminal station in synchronization with the frame pulse signal.

4. The wireless communication system according to claim 3,
wherein said second base station assigns one frequency band per terminal station and assigns all slots for a communication channel in the frame to the terminal station so that wireless communication of the TDMA method synchronizing with said first base station is executed with the terminal station.

5. The wireless communication system according to claim 1,
wherein said first base station is a base station of an existing cellular mobile communication system.

6. The wireless communication system according to claim 5,
wherein said second base station has a base station identifier as its own identifier to the terminal station and a terminal station identifier to be assigned to the terminal station which said first base station can accommodate as its own identifier to said first base station.

7. The wireless communication system according to claim 5,
wherein said second base station transmits to and receives from said first base station control information on the terminal station which has accessed to said second base station via a control channel, which is for said first base station to transmit/receive the control information to/from the terminal station.

8. The wireless communication system according to claim 7,
wherein location of the terminal station is registered in said service control station via said second base station and said first base station.

9. The wireless communication system according to claim 1,
wherein the local area network is an Ethernet network.

10. A base station, comprising:
a wireless communication part for performing wireless communication with a base station of a different wireless communication system and one or plural terminal stations;
a network interface part connected to a local area network; and
a controlling part for controlling said wireless communication part to transmit control information on the terminal station which performs wireless communication with said wireless communication part to a service control station of the different wireless communication system through the base station of the different wireless communication system.

11. The base station according to claim 10,
wherein said controlling part transmits a line use amount arisen from wireless communication with each of the terminal stations to the base station of the different wireless communication system and makes the service control station perform charging management on each of the terminal stations based on the line use amount of each of the terminal stations.

12. The base station according to claim 10, further comprising:
a frame pulse generating part for generating a frame pulse signal synchronizing with a frame of wireless communication in the different wireless communication system based on a control channel of wireless communication of a TDMA method provided by the different wireless communication system,
wherein said wireless communication part executes wireless communication with the terminal station in synchronization with the frame pulse signal generated by said frame pulse generating part.

13. The base station according to claim 12,
wherein said wireless communication part assigns one frequency band per terminal station and assigns all slots for a communication channel in the frame to the terminal station so that wireless communication of the TDMA method synchronizing with the different wireless communication system is executed with the terminal station.

14. The base station according to claim 10,
wherein the different wireless communication system is an existing cellular mobile communication system, and
wherein said wireless communication part has a base station identifier as its own identifier to the terminal station and a terminal station identifier of the different wireless communication system as its own identifier to the base station of the different wireless communication system.

15. The base station according to claim 10,
wherein the different wireless communication system is an existing cellular mobile communication system, and said wireless communication part transmits/receives control information on the terminal station, which has accessed said wireless communication part, to/from the base station of the different wireless communication system via a control channel of the different wireless communication system.

16. The base station according to claim 15,
wherein said controlling part controls said wireless communication part to transmit the control information on the terminal station, which has accessed said wireless communication part, to the base station of the different wireless communication system so that location of the terminal station is registered in the service control station.

17. The base station according to claim 10,
wherein the local area network is an Ethernet network.

18. A wireless communication method, comprising the steps of:
registering location of a terminal station in a service control station connected to a backbone network through a first base station connected to the backbone network;
performing wireless communication between a second base station connected to a local area network and the terminal station; and
transmitting a line use amount arisen from wireless communication between the second base station and the terminal station from the second base station to the service control station through the first base station.

19. The wireless communication method according to claim 18,
wherein the location of the terminal station is registered in the service control station through the first base station and the second base station.
